(19) United States
(12) Patent Application Publication
(10) Pub. No.: US 2002/0198026 A1
(43) Pub. Date: Dec. 26, 2002

(54) Method, communications system, and base station for transmitting signals with transmit diversity

(75) Inventor: Kari Niemela, Oulu (FI)

Correspondence Address: Cohen, Pontani, Lieberman & Pavane, Suite 1210, 551 Fifth Avenue, New York, NY, 10176, US

(73) Assignee: Nokia Corporation

(21) Appl. No.: 09/885,215

(22) Filed: Jun. 20, 2001

(51) Int. Cl. H04M 1/00

(52) U.S. Cl. 455/562; 455/561; 455/424

(57) ABSTRACT

The invention relates to a method for transmitting signals with transmit diversity from a base station of a radio access network of a communications system to a mobile terminal of said communications system. In order to allow for an improved performance of the transmission, it is proposed that signals are transmitted by at least one antenna providing different polarization planes. Signals can then be forwarded to the different polarization planes with a respective phase and/or amplitude determined according to a current feedback signal from the mobile terminal, thus providing signals of optimized quality to the mobile terminal. The invention equally relates to a radio communications system and to a base station for such a system which are suited to realize the proposed method.

### BACKGROUND OF THE INVENTION

1. Field of the Invention

The invention relates to a method for transmitting signals with transmit diversity from a base station of a radio access network of a communications system to a mobile terminal of said communications system. The invention equally relates to a radio communications system comprising at least one mobile terminal and a radio access network with at least one base station employing transmit diversity, and to such a base station.

2. Description of the Related Art

Radio communications systems employing diversity techniques for downlink transmissions, e.g., for WCDMA (Wide Band Code Division Multiple Access) downlink transmissions, are known.

In conventional radio communications systems employing transmit diversity, a base station of a radio access network is provided with two antennas of the same polarity. The base station then transmits downlink signals to a mobile terminal simultaneously via these two antennas with a predetermined phase difference. A closed loop, in which the mobile terminal supplies a feedback signal to the base station indicating the current quality of received signals, is used for adjusting the phase difference between the signals transmitted by the two antennas, in order to achieve an optimized quality of signals received by the mobile terminal.

The time variations of radio channels are smaller when the coherence bandwidth is high, which enables to adapt the polarization also with the quality reporting periods used in TDMA (Time Division Multiple Access).

In rural or quasi-open environments, the coherence bandwidth of rural environment is typically larger than the bandwidth of the WCDMA signal itself, which leads to fading of the transmitted signals and which prevents the system from operating optimally. Moreover, in such environments the antennas have to be installed spaced apart by at least several meters in order to achieve a diversity gain, because of the high correlation between the signals transmitted by the two antennas. However, in rural environments it is particularly difficult to find sufficient suitably spaced apart locations for installing the transmit antennas.

Moreover, different antenna types are required for rural environments and urban environment to optimize the performance. This means, on the one hand, that different designs are necessary, also with respect to the mechanical structure of the antennas, which makes the antennas more expensive. On the other hand, the environment cannot always be clearly classified as rural or urban, thus making it difficult in some cases to select the most suitable antennas.

These factors might even discourage operators completely from employing transmit diversity at least in rural environments. At the same time, it is in particular rural environments in which an extension of coverage is needed.

### SUMMARY OF THE INVENTION

It is an object of the invention to improve the performance of downlink transmissions in a radio communications system employing transmit diversity.

In is also an object of the invention to enable a reduction of the number or the size of antennas employed for downlink transmissions in such a radio communications system.

A method is proposed for transmitting signals with transmit diversity from a base station of a radio access network of a communications system to a mobile terminal of said communications system. According to the invention, the method comprises in a first step transmitting signals from the base station to the mobile terminal via at least two different polarization planes of at least one antenna assigned to the base station. Next, the base station receives a feedback information from the mobile terminal indicating the quality of signals received at the mobile terminal from the base station. Based on the feedback information, the base station then determines phases and/or amplitudes with which signals to be transmitted to the mobile terminal are to be fed to each of the polarization planes of the at least one antenna. The phases and/or amplitudes are determined in a way that they are suited to maximize the quality of the signals received at the mobile terminal. Signals that are to be transmitted by the base station to the mobile terminal are then transmitted via the polarization planes of the at least one antenna with the respective determined phase and/or amplitude.

Further, a radio communications system is proposed which comprises at least one mobile terminal and a radio access network with at least one base station employing transmit diversity. According to the invention, the base station on its part comprises at least one antenna with at least two different polarization planes for transmitting signals to mobile terminals. In addition, the base station comprises receiving means for receiving from a mobile terminal a feedback about the quality of signals received. These receiving means can have a dedicated receiving antenna, but they can also make use of the antenna provided for transmitting signals. Processing means of the base station are used for determining, based on feedback information received from a mobile terminal, optimized phases and/or amplitudes with which signals to be transmitted to the mobile terminal are to be fed to each of the polarization planes of the at least one antenna. The phases and/or amplitudes are determined again in a way that they are suited to maximize the quality of the signals received at the mobile terminal. Finally, the base station of the communications system of the invention comprises at least one transmitter for feeding signals to the at least two polarization planes of the at least one antenna with the respective determined phase and/or amplitude.

Also a base station for a radio communications system is proposed which comprises the same features as the base station of the proposed radio communications system.

It can be selected freely if only suitable phases, only suitable amplitudes or both are determined in the feedback loop for the transmission of signals. The phases and/or the amplitudes determined according to the invention for the polarization planes can moreover be determined as absolute value for each polarization plane. But equally, they can be determined, at least for one of the polarization planes, only in terms of a difference between the phases and/or the amplitudes that are to be employed for the different polarization planes.

The invention proceeds from the idea that transmit diversity cannot be achieved only with two spaced apart antennas employing the same polarization. Instead, at least one antenna can be used which is able to transmit signals via at least two different polarization planes. Since phase and/or amplitude of the signals fed to each of the polarization planes can be fixed separately, the resulting polarization of transmitted signals can then be optimized according to feedback information by a mobile terminal in order to achieve an optimized quality of the signals received by the mobile terminal.

It is an advantage of the invention that it enables a reduction of the number and of the total size of the required antennas, since a single antenna can be designed to comprise the at least two polarization planes. A single dual polarized antenna element, e.g., only requires half of the volume necessary for two co-polarized antenna elements. Even in case more than one antenna is employed, the invention at least allows to reduce the number of locations, since due to the different polarization planes, the antennas can be arranged at the same location.

The invention is of particular advantage for rural or quasi-open environments, in which the different polarization planes allow transmit diversity to be employed successfully, thus enabling a comprehensive concept without compromises or exceptions. With the invention, gain can also be provided in these environments, and coverage and quality of service are improved. In addition, the same antenna can be used in all environments without special network planning, which makes antennas and planning less expensive.

A further advantage is given by the fact that the same feedback information and the same steering algorithm can be used as are known for spaced apart diversity antennas.

In urban environments, the correlation between the signals transmitted with the different polarization planes will usually be poor due a coherence bandwidth that is narrower than the employed modulation bandwidth. The performance then does not vary per angle as it does in the case of rural environments. In case there is no or only an insignificant correlation between the signals transmitted by the different polarization planes, the invention can be employed for an adaptation to the environment, while in case there is a correlation between the signals transmitted by the different polarization planes, the invention can be employed for an adaptation to an optimum polarization.

Preferably, the at least one antenna is exactly one antenna with at least dual polarization planes, which makes the antenna configuration particularly small. The antenna may comprise to this end two differently polarized transmission elements. Alternatively, it would be possible to employ two or more antennas with different polarization planes, but in this case not only the polarization of transmitted signals would have to be matched to the requirements of the respective mobile terminal, but in addition the radiation pattern employed by the two antennas would have to be matched to each other.

It is moreover preferred that for each polarization plane, a dedicated transmitter is provided for feeding the signals that are to be transmitted with the respective determined phase and/or amplitude. The differences between the transmitters can be corrected by the feedback loop if it is fast enough. Advantageously, however, the transmitters are synchronized to each other, since otherwise the steering becomes more difficult and the result is less exact so that the optimal phase difference might not be achieved. It would also be possible to employ a single transmitter for both polarization planes by using in addition at least one phase shifter for providing the different polarization planes with signals of different phases.

The different polarization planes of the at least one antenna can be oriented in any direction. Advantageously, however, they the planes are orthogonal to each other, e.g. with a slope of +/−45° or 0/90° with respect to the vertical. Otherwise, a mutual coupling between the polarization planes will occur, which makes the controlling more difficult.

The quality of the signals received by the mobile terminal can be indicated by a variety of parameters. Advantageously, the quality is indicated by the signal-to-interference ratio, by the bit error probability, by the bit error ratio or a block error ratio, e.g. the frame error rate, by a downlink power control information commanded by the mobile terminal, or by the power level of the received signals.

The transmission from the base station to the mobile terminal can consist in particular in a single beam or a radiation pattern, the polarization of which is determined by the difference of the phases and/or amplitudes of the signals fed to the at least two different polarization planes. Alternatively, two distinct beams can be formed in order to achieve transmit diversity, the beams pointing to the same direction but having orthogonal polarization.

The invention can be employed in particular, though not exclusively, with WCDMA base stations.

Base stations designed according to the invention are particularly improved in performance when employed in rural or quasi-open environments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

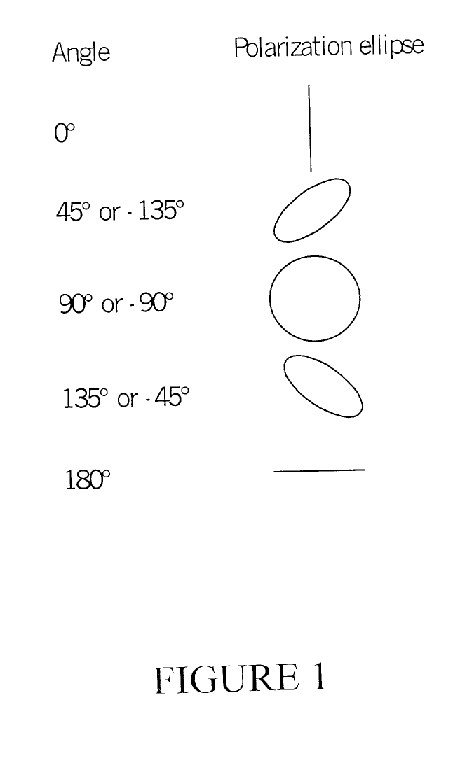

In the following, the invention is explained in more detail with reference to FIG. 1 which shows different polarization ellipses that may result in an embodiment of the invention.

### DETAILED DESCRIPTION OF THE PRESENTLY PREFERRED EMBODIMENTS

In an exemplary embodiment of a communications network of the invention, a mobile terminal communicates with a WCDMA base station of a radio access network. The base station is located in a rural environment. It is designed to employ a transmit diversity effected by adapting the polarization of transmitted beams in order to be able to provide the mobile terminal with signals of optimal quality.

More specifically, the base station comprises a slanted cross-polarized antenna with polarization planes having +/−45° angles to the vertical. In addition, the base station comprises two transmitters. The transmitters are synchronized to each other in order to meet the coherence requirements. Each transmitter is able to feed signals with a predetermined phase to one of the polarization planes of the antenna. The antenna is equally connected to a receiver. The transmitters are further connected to outputs of a processing unit, while the receiver is connected to an input of the processing unit.

The proposed adaptive polarization diversity is achieved by the described WCDMA base station as follows:

Signals that are to be transmitted by the base station to the mobile terminal are fed by the transmitters to the polarization planes of the antenna with a known phase difference, the polarization planes transmitting the signals as received to the mobile terminal.

The mobile terminal receives these signals and determines the signal-to-interference ratio as indication of the current quality of the received signals. Then, the mobile terminal transmits a feedback information to the base station including a direct or an indirect indication of the determined signal-to-interference ratio.

The base station receives the feedback information via its antenna and its receiver connected to the antenna. The receiver forwards the feedback information to the processing unit.

Based on the received indication of the signal-to-interference ratio and the phase difference currently employed for feeding signals to the two polarization planes of the antenna, the processing unit now determines a phase difference that is suited best to optimize the quality of signals received at the mobile terminal. The phase difference is set to this end to any desirable value between −180° and +180°, in steps of 45°. The absolute phases to be used by the two transmitters can then be determined, e.g., by deciding that the phase used by one of the transmitters is kept and that the phase used by the other transmitter is adjusted according to the determined phase difference. The processing unit informs each of the transmitters, or only one of them in case the other one keeps it phase, about a phase to be used for feeding signals to the polarization plane of the antenna to which they are connected.

The two polarization planes transmit the signals with the determined phase difference, thus forming a beam with a resulting elliptical polarization.

FIG. 1 shows different resulting polarization ellipses for different employed phase differences for slanted cross-polarized antenna. The phase differences are indicated as phase angles having values between 0° and 180° in steps of 45°.

FIG. 1 contains only the shape of the ellipses. The rotation of elliptical polarization is clockwise for positive and anti-clockwise for negative phase angles. The rotation typically makes no difference, as long as the antenna of the mobile terminal does not generate almost circular or significantly elliptical polarization.

In the whole, the communications system provides an adaptive closed loop polarization diversity which is of particular advantage in rural environments.

Thus, while there have shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for transmitting signals with transmit diversity from a base station of a radio access network of a communications system to a mobile terminal of said communications system, said method comprising:
transmitting signals from said base station to said mobile terminal via at least two different polarization planes of at least one antenna assigned to said base station;
receiving at said base station a feedback information from said mobile terminal indicating the quality of signals received at said mobile terminal from said base station;
determining based on said feedback information phases and/or amplitudes with which signals to be transmitted to said mobile terminal are to be fed to each of said polarization planes of said at least one antenna, which phases and/or amplitudes are suited to maximize the quality of the signals received at said mobile terminal; and
transmitting signals by said base station to said mobile terminal via said polarization planes of said at least one antenna with the respective determined phase and/or amplitude.

2. The method of claim 1, wherein the indication of the quality of signals received at the mobile terminal includes at least one of the signal-to-interference ratio, the signal level, the block or bit error ratio, a downlink power control information, and a bit error probability estimate.

3. The method of claim 1, wherein said signals are transmitted by said base station to said mobile terminal via the polarization planes of said at least one antenna with the respective determined phase and/or amplitude in form of a single beam or a single radiation pattern.

4. The method of claim 1, wherein said signals are transmitted by said base station to said mobile terminal via the polarization planes of said at least one antenna with the respective determined phase and/or amplitude in form of at least two beams or at least two sets of radiation patterns with orthogonal polarization, said at least two beams or radiation patterns pointing essentially to the same direction.

5. A radio communications system comprising at least one mobile terminal and a radio access network with at least one base station employing transmit diversity, the base station including:
at least one antenna comprising at least two different polarization planes for transmitting signals to mobile terminals;
receiving means for receiving from a mobile terminal a feedback about the quality of signals received at said mobile terminal;
processing means for determining, based on the feedback information received from said mobile terminal, optimum phases and/or amplitudes with which signals to be transmitted to said mobile terminal are to be fed to each of said polarization planes of said at least one antenna, which phases and/or amplitudes are suited to maximize the quality of the signals received at said mobile terminal; and
at least one transmitter for feeding signals to the at least two polarization planes of said at least one antenna with the respective determined phase and/or amplitude.

6. The radio communications system of claim 5, wherein the at least one antenna is one antenna.

7. The radio communications system of claim 5, wherein the at least one transmitter comprises a dedicated transmitter for each of the polarization planes of the at least one antenna.

8. The radio communications system of claim 5, wherein the at least two different polarization planes comprise two polarization planes which are arranged orthogonal to each other.

9. A base station for a radio access network of a communications system, said base station employing transmit diversity and comprising:
at least one antenna comprising at least two different polarization planes for transmitting signals to mobile terminals;
receiving means for receiving from a mobile terminal a feedback about the quality of signals received at said mobile terminal;
processing means for determining, based on the feedback information received from said mobile terminal, optimum phases and/or amplitudes with which signals to be transmitted to said mobile terminal are to be fed to each of said polarization planes of said at least one antenna, which phases and/or amplitudes are suited to maximize the quality of the signals received at said mobile terminal; and
at least one transmitter for feeding signals to the at least two polarization planes of said at least one antenna with the respective determined phase and/or amplitude.

10. The base station of claim 9, wherein the at least one antenna is one antenna.

11. The base station of claim 9, wherein the at least one transmitter comprises a dedicated transmitter for each of the polarization planes of the at least one antenna.

12. The base station of claim 9, wherein the at least two different polarization planes comprise two polarization planes which are arranged orthogonal to each other.
